(19) United States
(12) Patent Application Publication
(10) Pub. No.: US 2012/0140503 A1
(43) Pub. Date: Jun. 7, 2012

(54) Head Lamp for Vehicle

(75) Inventors: Byoung Suk AHN, Suwan-si (KR); Hak Bong Kim, Daegu (KR)

(73) Assignee: HYUNDAI MOTOR COMPANY, Seoul (KR)

(21) Appl. No.: 13/210,525

(22) Filed: Aug. 16, 2011

(30) Foreign Application Priority Data
Dec. 7, 2010 (KR) 10-2010-0124520

(51) Int. Cl. F21V 7/00; B60Q 1/04

(52) U.S. Cl. 362/514; 362/538

(57) ABSTRACT

A head lamp for the vehicle includes an upper light source for illuminating a high beam, a lower light source for illuminating a low beam, a reflector for reflecting light emitted from the upper light source and the lower light source, and a projection lens, provided at a front portion of the reflector, for illuminating the reflected light outwardly. Since the low-beam module and the high-beam/low-beam module are employed in a unitary body by using the plurality of light sources, various light distribution patterns can be formed to maximize a merchantable quality.

### CROSS-REFERENCE TO RELATED APPLICATION

This application is based on and claims priority from Korean Patent Application No. 10-2010-0124520 filed Dec. 7, 2010, the entire contents of which application is incorporated herein for all purposes by this reference.

### BACKGROUND OF INVENTION

1. Field of Invention

The present invention relates to a head lamp for a vehicle, and more particularly, to a head lamp for a vehicle which can employ a low-beam module and a high-beam/low-beam module through a plurality of light sources.

2. Description of Related Art

In general, a head lamp for a vehicle is installed on front left and right sides of the vehicle to enable a driver to drive the vehicle through illumination in a front direction of the vehicle during the nighttime driving.

The head lamp includes a high-beam lamp serving as a high beam to illuminate a distant place, and a low-beam lamp serving as a low beam to prevent dazzling of an opposite driver.

Accordingly, the driver secures a front field of vision by appropriately adjusting the high beam and the low beam in accordance with surroundings. Since the high beam is a hindrance to the opposite driver, the low beam is usually used at areas except for a secluded spot where there is no vehicular traffic.

Meanwhile, as LED light sources having a semi-permanent lifespan are applied to the lead lamp, a degree of freedom in lamp design is improved, so that a differentiated design for the head lamp is required. Recently, a head lamp having a multiple-light source image using a plurality of LED light sources is realized.

However, when functions of the high beam and the low beam are realized as described above, if the lighting regions are differently set, a merchantable quality in design is deteriorated. In addition, a size of an optical system should be increased so as to satisfy the respective functions.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, various aspects of the present invention have been made to solve the above-mentioned problems occurring in the prior art while advantages achieved by the prior art are maintained intact.

Various aspects of the present invention provide for a head lamp for a vehicle which can employ a low-beam module and a high-beam/low-beam module through a plurality of light sources.

Various aspects of the present invention provide for a head lamp for a vehicle including an upper light source for illuminating a high beam, a lower light source for illuminating a low beam, a reflector for reflecting light emitted from the upper light source and the lower light source, and a projection lens, provided at a front portion of the reflector, for illuminating the reflected light outwardly.

With the head lamp according to various aspects of the present invention, since the low-beam module and the high-beam/low-beam module can be employed in a unitary body by using the plurality of light sources, various light distribution patterns can be formed to maximize a merchantable quality.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view illustrating an exemplary illumination module designated for a low beam in a head lamp for a vehicle according to the present invention.

FIG. 2 is a cross-sectional view illustrating an exemplary illumination module for simultaneously illuminating a high beam and a low beam in a head lamp for a vehicle according to the present invention.

FIG. 3(a) is a view illustrating an example of an illumination module designated for a low beam in a head lamp for a vehicle according to the present invention.

FIG. 3(b) is a view illustrating an example of a low beam function in an illumination module for simultaneously illuminating a high beam and a low beam in a head lamp for a vehicle according to the present invention.

FIG. 3(c) is a view illustrating an example of a high beam function in an illumination module for simultaneously illuminating high beam and a low beam in a head lamp for a vehicle according to the present invention.

FIG. 4(a) is a view illustrating an exemplary screen pattern during lighting of a low-beam dedicated module by a head lamp for a vehicle according to the present invention.

FIG. 4(b) is a view illustrating an exemplary screen pattern during lighting of a low-beam in a high-beam/low-beam common module by a head lamp for a vehicle according to the present invention.

FIG. 4(c) is a view illustrating an exemplary screen pattern during lighting of a high-beam in a high-beam/low-beam common module by a head lamp for a vehicle according to the present invention.

FIG. 5(a) is a view illustrating a low-beam screen pattern composed of a combination of screen patterns of FIGS. 4(a) and 4(b).

FIG. 5(b) is a view illustrating a high-beam screen pattern composed of a combination of screen patterns of FIGS. 4(a), 4(b), and 4(c).

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

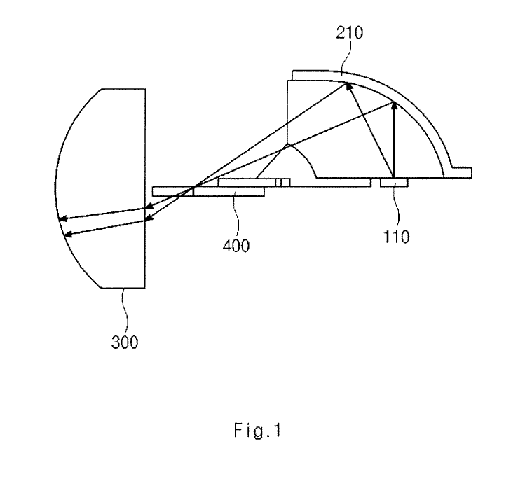

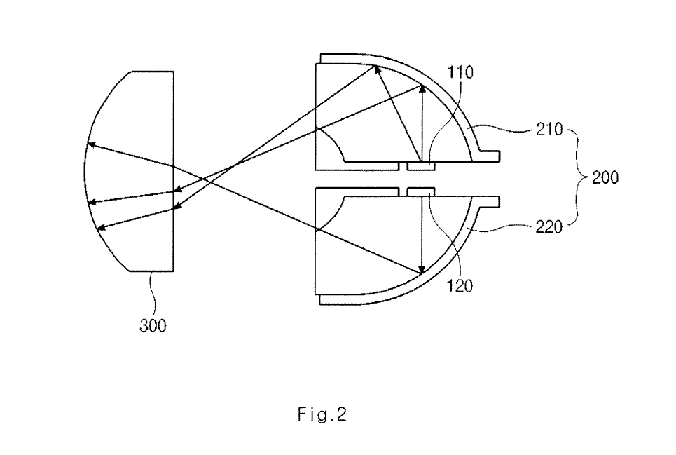

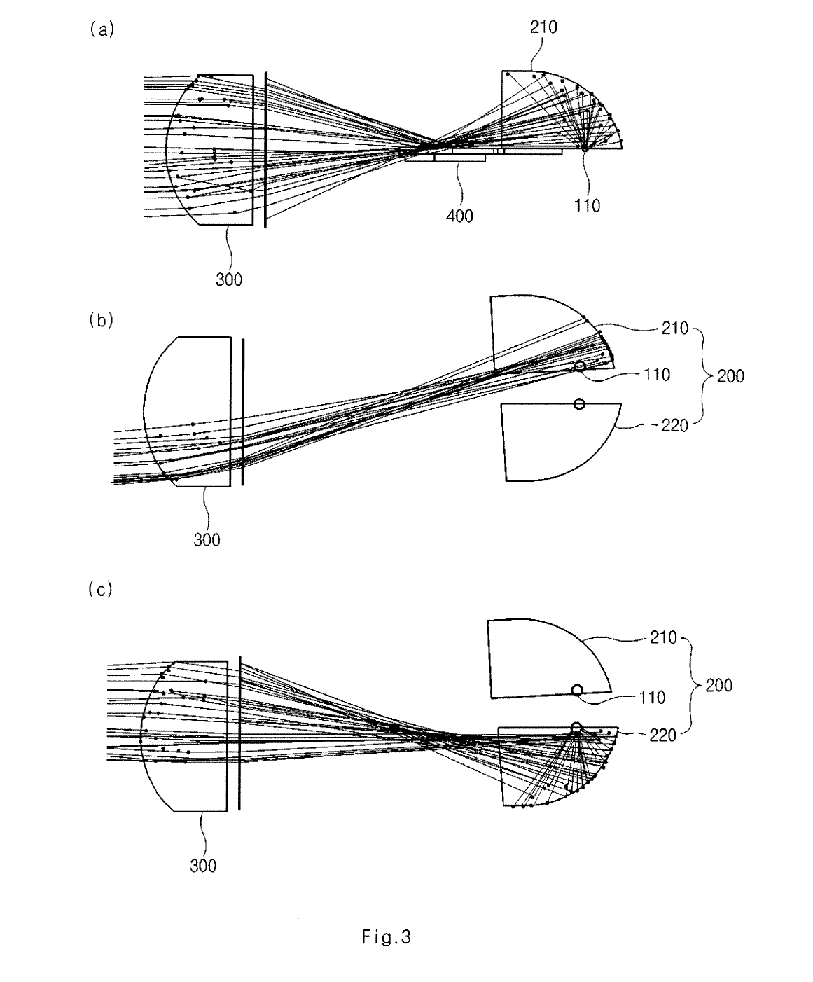

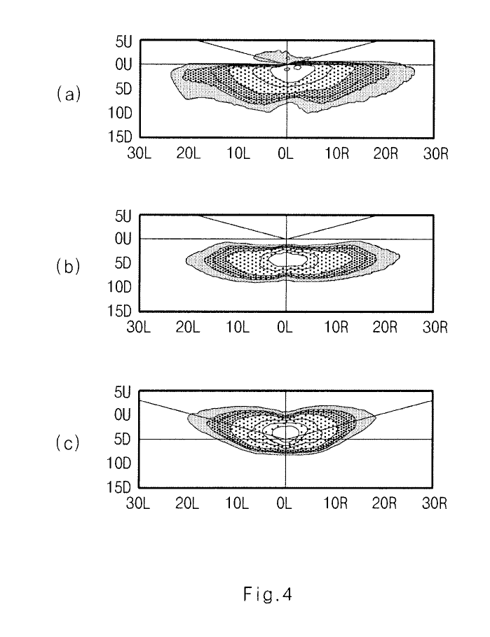

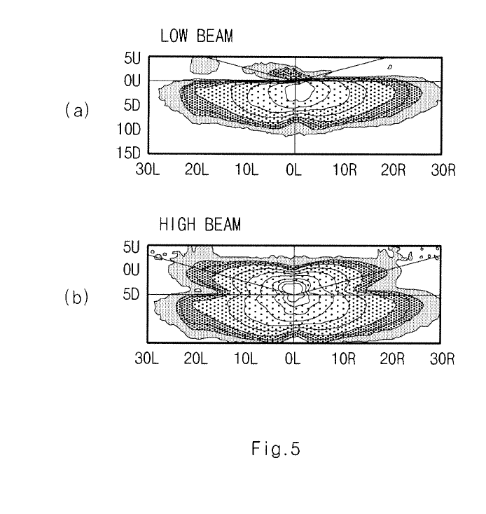

FIGS. 1 to 5 illustrate a head lamp for a vehicle according to the present invention. The head lamp is provided with at least one low-beam module and at least one high-beam/low-beam module. FIG. 1 is a cross-sectional view illustrating an illumination module designated for a low beam in the head lamp for the vehicle according to the present invention. FIG. 2 is a cross-sectional view illustrating an illumination module for simultaneously illuminating a high beam and a low beam in the head lamp for the vehicle according to the present invention. FIGS. 3(a) to 3(c) are views illustrating examples of the illumination module designated for the low beam, a low beam function in the illumination module for simultaneously illuminating the high beam and the low beam, and a high beam function in the illumination module for simultaneously illuminating the high beam and the low beam in the head lamp for the vehicle according to the present invention. FIGS. 4(a) to 4(c) and 5(a) and 5(b) are views illustrating lighting states and screen patterns of a head lamp for a vehicle according to the present invention.

A head lamp for a vehicle according to the present invention is characterized in that, as shown in FIGS. 1 to 5, the light emitted from an upper light source 110 and a lower light source 120 is reflected by an upper reflector 210 and a lower reflector 220, and then is illuminated outwardly through a projection lens 300, thereby employing a low-beam module and a high-beam/low-beam module in a unitary body by using the plurality of light sources.

Each component of the head lamp for the vehicle according to the present invention will be described with reference to the accompanying drawings.

First, the head lamp according to the present invention includes a plurality of light sources provided in the head lamp, the reflector 200 for housing the light sources therein, the projection lens 300 for illuminating the light reflected from the reflector 200 in an outward direction.

FIG. 1 shows a low-beam module, and it is desirable that the low-beam module includes the upper module 110 and the upper reflector 210 for reflecting the light emitted from the upper light source in a forward direction.

A shield 400 is interposed between the upper reflector 210 and the projection lens 300 to shield the light, which can cause an opposite driver to dazzle, among the light reflected from the upper reflector 210 and then emitted forwardly through the projection lens 300.

As shown in FIG. 2, the light source capable of simultaneously implementing the high beam and the low beam includes the upper light source 110 and the lower light source 120. The upper light source 110 can illuminate the low beam, and the lower light source 120 can illuminate the high beam.

The reflector 200 houses the upper light source 110 and the lower light source 120, and is adapted to reflect the light emitted from the upper light source 110 and the lower light source 120 in the forward direction.

Meanwhile, it is desirable that the reflector 200 is constituted by the upper reflector 210 and the lower reflector 220.

In this instance, the upper reflector 210 is provided at the upper light source 110 to illuminate the low beam. The lower reflector 220 is provided at the lower reflector 220 to illuminate the high beam.

The projection lens 300 is disposed in front of the reflector 200 housing the upper reflector 210 and the lower reflector 220 to illuminate the light, which is emitted from the upper light source 110 and the lower light source 120 and reflected by the upper reflector 210 and the lower reflector 220, in the outward direction.

When the low beam is illuminated, the shield can be omitted by adjusting the upper reflector 210 to illuminate the light to the cut-off line in the downward direction, instead of shielding the light which causes the opposite driver to dazzle.

As described above, the present invention includes the upper light source 110, the lower light source 120, the reflector 200, and the projection lens 300, and enables the implementation of the high-beam/low-beam common module.

Therefore, the head lamp employing a plurality of light sources is implemented by combining the illumination module (refer to FIG. 1) designated for the low beam and the illumination module (refer to FIGS. 2) for simultaneously illuminating the high beam and the low beam.

The operation and effect of the present invention will now be described.

As shown in FIGS. 1 and 2, the light emitted from the upper light source 110 and the lower light source 120 is reflected by the upper reflector 210 and the lower reflector 220, and then is illuminated through the projection lens 300 in the outward direction.

In this instance, the light emitted from the upper light source 110 is reflected by the upper reflector 210 to illuminate the low beam, and the light emitted from the lower light source 120 is reflected by the lower reflector 220 to illuminate the high beam.

On the other hand, as shown in FIG. 3(a), when the low beam is illuminated through the head lamp, the shield 400 cuts off the light that is directed to the upper end of the cut-off line that causes the opposite driver to dazzle, and thus the low-beam dedicated module can be provide.

Further, in implementing the high-beam/low-beam common module, the light that causes the dazzling is lowered to the lower end of the cut-off line through adjustment of the upper reflector 210.

As a result, as shown in FIG. 5(a), when the low beam is illuminated, the illumination is performed as shown in FIGS. 3(a) and 3(b), and thus the low beam is illuminated as shown in FIG. 5(a) by a combination of screen patterns as shown in FIGS. 4(a) and 4(b).

Further, as shown in FIG. 5(b), when the high beam is illuminated, the illumination is performed as shown in FIGS. 3(a), 3(b), and 3(c), and thus the high beam is illuminated as shown in FIG. 5(b) by a combination of screen patterns as shown in FIGS. 4(a), 4(b), and 4(c).

For convenience in explanation and accurate definition in the appended claims, the terms upper or lower, front, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A head lamp for a vehicle, comprising:
an upper light source for illuminating a high beam;
a lower light source for illuminating a low beam;
a reflector for reflecting light emitted from the upper light source and the lower light source; and
a projection lens, provided at a front portion of the reflector, for illuminating the reflected light outwardly.

2. The head lamp according to claim 1, wherein the reflector includes an upper reflector and a lower reflector, in which the upper reflector is provided at the upper light source to illuminate the low beam, and the lower reflector is provided at the lower reflector to illuminate the high beam.

3. The head lamp according to claim 1, wherein the upper light source, the lower light source, the reflector, and the projection lens provide a low-beam dedicated module and a high-beam/low-beam common module.

4. The head lamp according to claim 2 , wherein light is lowered to a lower end of a cut-off line by adjusting the upper reflector when the high-beam/low-beam common module is implemented.
